(19) United States
(12) Patent Application Publication
(10) Pub. No.: US 2025/0209483 A1
(43) Pub. Date: Jun. 26, 2025

(54) LOCATION STRATEGY SYSTEMS AND METHODS

(71) Applicant: Avison Young, Toronto (CA)

(72) Inventors: Martin Jepil, Vaughan (CA); Olivier Geert Maene, Savannah, GA (US); Christopher Thomas Toomey, Park Ridge, IL (US)

(21) Appl. No.: 18/389,976

(22) Filed: Dec. 20, 2023

(51) Int. Cl. G06Q 30/0204

(52) U.S. Cl. CPC G06Q 30/0205

(57) ABSTRACT

Location strategy systems and methods are provided for determining a demand gap in services provided to a geographic location. Regular geographic polygons are utilized as the basis for aggregating multi-dimensional data to trade areas surrounding the polygons based on drive-time isochrones.

### FIELD OF THE INVENTION

The present disclosure relates to computing systems and methods for geographic location analysis, and particularly to computer aided business location strategy in commercial real estate.

### BRIEF SUMMARY

According to a first aspect, there is provided a computer implemented method of assisted location strategy, carried out by a computer system, the method comprising: ingesting demographic, business, and service data into the computer system; receiving an input from a user specifying an area of interest; generating a list of regular geographic polygons falling within the area of interest; and for each regular geographic polygon, generating a respective custom geographic polygon as a trade area for the regular geographic polygon, the custom geographic polygon generated from the centroid of the regular geographic polygon and extending beyond the area of the regular geographic polygon; aggregating the demographic, business, and service data to the custom geographic polygons and associating the aggregated data with the regular geographic polygon; training a demand and service level model with use of the aggregated data; determining a demand gap for each regular geographic polygon with use of the trained model and the aggregated data associated with the regular geographic polygon; and presenting the demand gap to the user via a display device of the computer system.

In some embodiments, each regular geographic polygon is a level 7 hexbin of an H3 geographic partitioning system.

In some embodiments, each custom geographic polygon is an isochrone generated from the centroid of each hexbin.

In some embodiments, each isochrone is defined using a 30-minute drive time.

In some embodiments, aggregating the demographic, business, and service data to the isochrones includes: for each isochrone, determining whether each standard geographic polygon with which the data is associated falls within or intersects with the isochrone, and if so, associating the standard geographic polygon with the isochrone; and for each isochrone, aggregating the data of the associated standard geographic polygons into new data associated with the isochrone.

Some embodiments further provide for, prior to aggregating the data to the isochrones: aggregating geographic location-based data to each standard geographic polygon, including, determining whether the geographic location with which the geographic location-based data is associated falls within the standard geographic polygon, and if so, aggregating the geographic location-based data to the standard geographic polygon generating data associated with the standard geographic polygon.

In some embodiments, aggregating the data into new data associated with the isochrone comprises performing an inverse distance weighting of the data of the associated standard geographic polygons, for data which is mean based.

In some embodiments, wherein aggregating the data into new data associated with the isochrone comprises performing a variation of inverse distance weighting of the data of the associated standard geographic polygons, according to

$${s}_{p} = {\sum }_{i = 1}^{n} ( \frac{{s}_{i}}{{d}_{i}^{p}} )$$

for data which is sum based.

In some embodiments, the demand and service level model is trained to return an expected level of demand associated with a hexbin based on the aggregated data associated with the respective isochrone of the hexbin.

In some embodiments, determining the demand gap for each hexbin comprises comparing the expected level of demand returned by the demand and service level model for the hexbin with a demand determined from the aggregated data associated with that hexbin.

According to another aspect, there is provided a computer system for implementing a method of assisted location strategy, the computer system being configured to: ingest demographic, business, and service data into the computer system; receive an input from a user specifying an area of interest; generate a list of regular geographic polygons falling within the area of interest; and for each regular geographic polygon, generate a respective custom geographic polygon as a trade area for the regular geographic polygon, the custom geographic polygon generated from the centroid of the regular geographic polygon and extending beyond the area of the regular geographic polygon; aggregate the demographic, business, and service data to the custom geographic polygons and associate the aggregated data with the regular geographic polygon; train a demand and service level model with use of the aggregated data; determine a demand gap for each regular geographic polygon with use of the trained model and the aggregated data associated with the regular geographic polygon; and present the demand gap to the user via a display device of the computer system.

In some embodiments, the computer system is further configured to, prior to aggregating the data to the isochrones: aggregate geographic location-based data to each standard geographic polygon, including, determining whether the geographic location with which the geographic location-based data is associated falls within the standard geographic polygon, and if so, aggregating the geographic location-based data to the standard geographic polygon generating data associated with the standard geographic polygon.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is a schematic block diagram of a business location strategy system according to an embodiment.

FIG. 2A illustrates an example geographic level partitioning according to that used in a government census tract based database.

FIG. 2B illustrates an example geographic level partitioning according to that used by a standard hexbin based database.

FIG. 3 illustrates multiple resolution levels of hexbin geographic partitioning.

FIG. 4 illustrates the difference between a geographic circle centered on a centroid versus an isochrone based on travel times from the centroid according to an embodiment.

FIG. 5 is a process flow diagram of a method of business location strategy according to an embodiment.

FIG. 6 is a process flow diagram that further details the ingestion, aggregation, and transformation process 510 of FIG. 5 according to an embodiment.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the scope of an invention as defined by the appended claims.

### DETAILED DESCRIPTION

Modern computer systems are frequently employed to assist decision making in the context of commercial real estate (CMR). Such systems enable querying, combining, and modeling of qualitative locational and site-specific spatial attributes, sourced from various proprietary, public, and third-party sources, across a range of abstract and real-world geographic units for the purpose of deriving the quantitative outputs that aid real estate decision-making. Often these outputs are provided graphically to a user in the form of charts and/or geographic map output with multiple graphical overlays and/or icons for presenting relevant information to the user. Generally, a variety of location strategy use cases may be addressed, customizable for business-specific users and their strategic locational and site-specific spatial considerations across various industries, including professional services, finance, law, healthcare, retail, residential, education, government, manufacturing, logistics, automotive, mining, energy, and others.

In the context of commercial real estate, being able to identify the optimal site to locate a business is of great value. The problem of location strategy, however, is not a trivial one. There are multiple potential considerations for determining a favorable site, including access to the customer base, the talent pool, and other points of interest, while also considering proximity to suppliers and partners, and maximizing distance from competitive businesses. One of the fundamental considerations for assessing potential geographic locations for building a new commercial facility is whether or not those geographic locations possess an increased or favorable return on investment (ROI) in comparison with other sites, i.e. whether those locations are currently comparatively underserved. In the case of healthcare, for example, an equivalent but slightly more specific consideration is whether or not the potential geographic locations would provide an increased or favorable number of billable appointments in comparison to other potential locations for development.

In general, the aforementioned computer systems have been applied to assist in the problem of optimizing location strategy, including the determination of (1) favorable locations utilizing a series of location and site-specific spatial attributes and (2) the favorable use of a given location across a set of site-specific uses. In the former use case, the output is described as a specific spatial location, whether expressed as a specific property or geographic unit, whereas the latter use case can be described as either (a) favorable asset classes for a site or (b) for a particular asset class, the favorable set of site-specific characteristics.

There are a myriad of platforms that tackle these particular problems, taking a few distinct approaches. However, known approaches to assisting in these areas are problematic in that they can suffer from inconsistencies in geographic partitioning of data, perform only a superficial analysis, and often the results are presented to the user in a disjointed and incomplete manner relying heavily on the individual judgment of a user. The simplest platforms tend to allow the user to layer descriptive datasets in an interactive mapping environment, guiding the user from one dataset to the next until the user develops an intuitive picture of optimal sites. Other platforms may take a slightly more complex approach by scoring locations based on a combination of descriptive datasets which has the advantage of providing more focused exploration.

Existing systems include a wide variety of approaches, utilize a multitude of different techniques, and exhibit various distinguishing characteristics. Some systems have both shared and distinct datasets that define the focus and complexity of their respective platforms. Some are limited strictly to demographic datasets, including population characteristics such as age, income, education, gender, racial and other relevant data points, while others offer more targeted datasets such as consumer spending or mobility-based metrics. Some known systems are based on the use of hexbins, evaluating overall and asset-specific investment grades, while others are based on the use of postal codes in evaluating CRE investments across different sectors using largely financial metrics of assets and allowing CRE investors to locate geographic areas based on user-selected weightings. Other systems use census tracts and evaluate residential investments with different indicators across financial performance, risk, and desirability. In some known approaches, retail tenant recommendations are developed based on identification of traditionally co-located retailers and performing a gap analysis. In others a self-storage location strategy tool evaluates census tracts based on demographic-based indicators of consumer demand and evaluates known self-storage facilities and possible construction.

Preferably, the process of searching for the optimal site should include multiple various considerations in an intuitive user experience, which allows a user to choose specific location criteria while also directing the search across specific geographies. Finally, a system should provide the most opportunistic sites that match the desired criteria and include a short list of options that can be used for comparison in the decision-making process.

The computer systems and methods of the embodiments described herein improves on known approaches by providing for the estimation of a service demand gap with greater accuracy, with improved intelligibility, and more intuitively. In order to achieve these advantages, the systems and methods of the embodiments herein adopt a number of considerations and approaches to solving the problem as described below.

Accurately estimating potential demand (also referred to as unmet demand or the “demand gap” herein) of locations in a given geography is not trivial. In order to determine an approximation or an estimate of the “unmet demand” or the “demand gap” at a location for some industry or service, a comparison is made between the expected level of demand for the service in a given geographic trade area associated with the location and the service levels actually being provided there. The former is estimated by using a statistical or machine learning model to assign or associate combinations of various demographic and business dimensions and other data attributable to an area with an expected quantity of service providers in that area. The latter is determined directly from an assessment of actual service providers present in the same geography. Because of the disparate forms taken by the source data upon which these are based, the embodiments include a careful process of transforming and aggregating data from different domains, including but not limited to geographic, business or industry of interest, and demographic data, to a standardized set of geographic data polygons for storage and display rather than using the disparate and sometimes overlapping geographic data polygons by which the various different source databases are structured. As will be described in further detail below, this transformation and aggregation entail creating customized geographic trade areas defined by driving time isochrones and assigning them to the centroids of the standardized polygons, aggregating the necessary tabular data using these customized geographic polygons, and estimating the unmet demand for each of the standard polygons by comparing actual data with the expected demand estimated by the model.

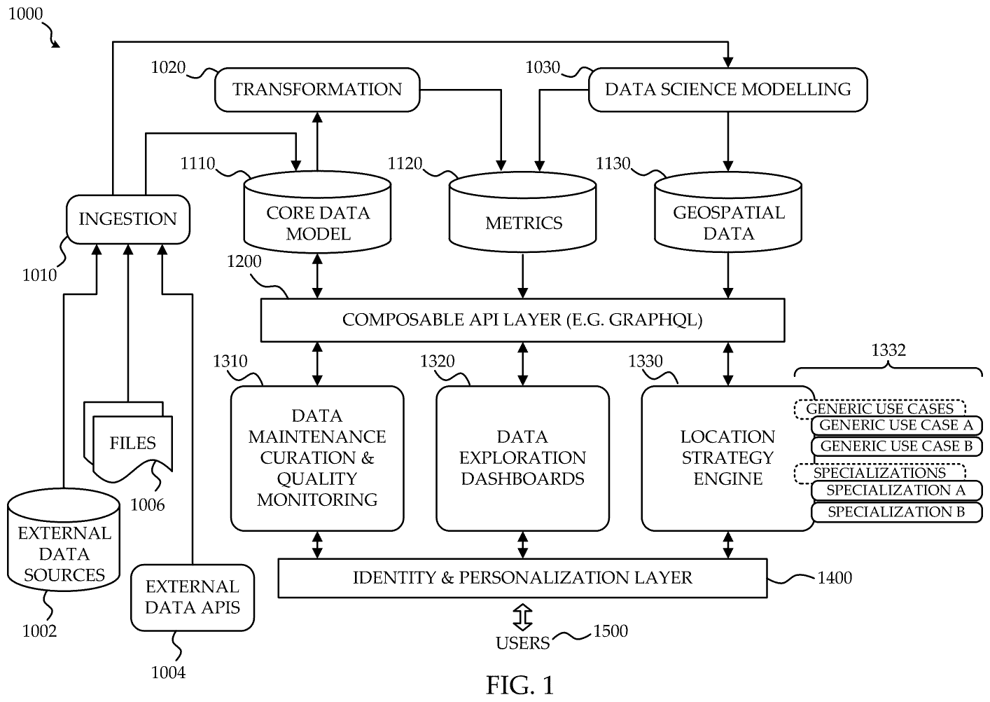

With reference to FIG. 1, a business location strategy system 1000 according to an embodiment will now be discussed.

Multiple datasets which form the basis and ground truth for all of the modeling and analysis performed by the system 1000 include external data sources 1002, such as private sector and government data bases, external data APIs 1004, such as geocoding, hexbin, and isochrone APIs, and other files 1006, such as various proprietary geographic boundary data and containers. Other examples of external and proprietary data include population segmentations by age, gender, etc.; employment details such as number of workers, number of job postings, and average income by occupation and industry; and specific locations of retailers, employers, or healthcare providers. Each of these data sources are fed into a common ingestion process 1010 which distributes and forwards the data largely unmodified into the various elements of the system, some of which perform further transformation thereon or further processing or aggregation thereof.

The ingestion process 1010 provides some data without any transformation directly to the data model database 1110 where it is stored. These typically include factual data such as property attributes. Some data stored on the core data model 1110 typically need to be aggregated and transformed to be used, and that data is provided from core data model 1110 to an aggregation and transformation process 1020, for aggregation into actual metrics (i.e. summed, averaged, counted, etc.) for storage in the metrics database 1120. Data stored in the metrics database 1120 include, for example, total population, population density, average rent per square foot, etc. Some data is provided by the ingestion process 1010 to data science modeling process 1030 which also processes the incoming data, but more than merely aggregation or transformation, data science modeling 1030 processes the incoming data using a series of operations or algorithms that create new datasets such as predictive models of current and future performance indicators which then flow from the data science modeling process 1030 to the metrics database 1120. Examples include predicted operating income of a commercial property, capital value of a property, sales of a product from a location, or number of professionals employed at a location. Furthermore, indexed scoring and ranking of defined points and boundaries can be based on predictive outputs and can be provided by visualization and filtering of these points and boundaries on a map or in a list. The example performance indicators can be applied to specific points, or to specific boundaries, and those can be filtered or searched based on an overall score, underlying score, or other non-scored attributes of the point or shape. Examples include a list of properties and their predicted income operating as an office building or as a multifamily building, and ranking the list by the greatest difference between those incomes to identify opportunities for a conversion; a list of vacant land parcels with specific local zoning codes and their normalized scores based on population demographics within a one hour drive time to identify opportunities for a retail development with access to the greatest spending power from a targeted demographic segment; or as detailed further herein a map of hexagons showing the difference between the actual number of professionals needed to provide a service within a trade area and the estimated number of professionals in demand for that service based on multiple factors within the trade area.

Some of the data processed by the data science modeling process 1030 are not metrics but rather are geospatial boundaries such as trade area isochrones discussed further below. The geographic data are provided by the data science modeling process 1030 for storage in the geospatial database 1130. Some other examples are defined points and boundaries for scoring, generated through programmatic, proprietary, or public means. Examples include proprietary boundaries of market segmentations; political and administrative boundaries like postal codes and census tracts; isochrones around a series of reference points such as subway stations or an owned or lease portfolio; and programmatic shapes like H3 “hexbins” or grids.

The transformed datasets and models are made available to an application layer using a composable API layer 1200 that allows data to be combined from various sources, specifically, the core data model database 1110 (e.g. a core real estate data model database 1110), the metrics database 1120, and the geospatial database 1130 for specific application use cases. The composable API layer 1200 provides access to metrics data from the metrics database 1120 as well as geospatial data from the geospatial database 1130 for access by the various applications of the application layer discussed below. The composable API layer 1200 also retrieves data from and provides data to the core data model database 1110 to allow the applications to access as well as to write-back into the core data model. For example, some property attributes form part of property intelligence applications, and need to be updated in the core data model from time to time. The data stored in the metrics database 1120 and the geospatial database 1130 are derived i.e. transformed or processed factual data and do not need to be modified by the applications.

In communication with the composable API layer is the application layer including at least three processes, namely, data maintenance curation and quality monitoring 1310, data exploration dashboards 1320, and a location strategy engine 1330. Data maintenance and quality monitoring 1310 allows users to make corrections to the core data model (e.g. correct a property attribute) and to monitor for data quality including searching for potential outliers, duplicates, or inconsistencies to help target corrections to the core data model. Data exploration dashboards 1320 provide tableau dashboards and the like, which retrieve through the API layer, various data for visualization. The location strategy engine 1330 is the core of the application layer for the general spatial site finding use cases and it also supports the addition of extension specializations such as healthcare. In some embodiments, the core data (e.g. core real estate data) is also viewable via analytics dashboards (not shown) and cross links any drill down detail between applications. Generic use cases (A, B, . . . ) and specializations (A, B, . . . ) 1322 are UI modes that are built on top of the location strategy engine 1330. Generic use cases include the location strategy tool UI described below, while specialization use cases are UI submodes, e.g. a healthcare version of the location strategy tool.

Coupled to the three processes of the application layer is an identity and personalization layer 1400 through which the system 1000 is accessed by users 1500 using a hardware interface typically including input and display devices such as a mouse, keyboard, and monitor. The common identity and personalization layer 1400 governs authentication, authorization, and profiles for all users 1500 accessing the system 1000.

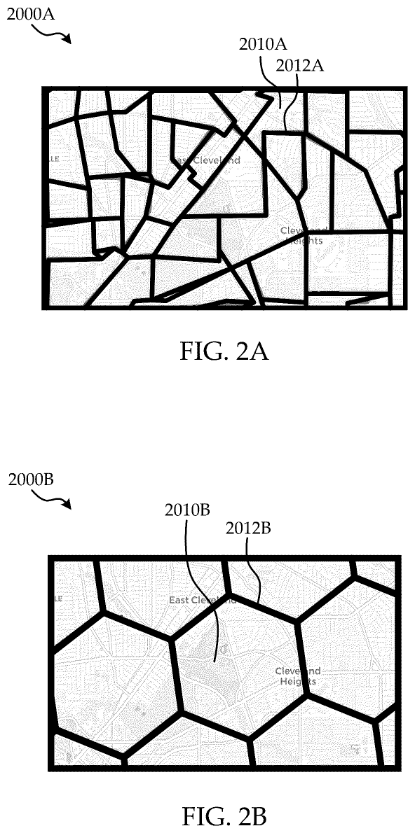

The process of estimating unmet demand uses a geographic partitioning of the geography which is being analyzed to process and present data. This is referred to as the geographic level and is generally required for the storage of data, the discretization of the display results, and facilitates processing and data analysis. The geographic level used to process and display data is particularly important, as there are advantages and disadvantages to using standard forms (e.g. hexbins in which each geographic polygon's centroid is regularly spaced apart from adjacent centroids) versus using existing, typically governmental geographic structures (e.g. census tract or zip code level). A standard example of a census tract geometry 2000A is illustrated in FIG. 2A, while an example of a standard hexbin form of geographic level partitioning 2000B is illustrated in FIG. 2B.

There are many considerations that determine the selection of the geographic level used to store, process, and display data. First, the display level or level of discretization of display information, should be appropriately sized, neither too large nor too small. If the display level is too large, or equivalently resolution is too low, differentiating between relevant areas closer than the lowest display unit will not be possible, as the data will be presented uniformly across that overly large lowest display unit. Having too fine a display level or equally too high a resolution creates issues both in terms of data storage and processing performance and would provide no meaningful partitioning for generation of averages and statistical data, nor for a user to utilize or refer to. Ideally, the level of storage, processing, and display granularity is sufficient to meaningfully present and differentiate different geographic areas (e.g. of a city) without processing or storage performance issues. Additionally, it is preferable for the geographic areas to be congruent standardized geographic polygons in order to appropriately compare different regions, in some cases, widely separated.

Although most existing geographic levels, such as county or zip, are generally not specific enough, one existing geographic level, namely, the census tract level, such as depicted in FIG. 2A, is typically of an appropriate resolution for storage and display of data. It is of a high enough resolution to facilitate differentiation between different areas within a city, CBSA (Core Based Statistical Area), etc., while still having sufficiently large data areas with which to make meaningful decisions. Although most of the data ingested from external sources typically is at the census tract level, which would allow for a relatively easier ETL (Extract, Transform, and Load) process, census tracts come in many different shapes and sizes, which makes it difficult to compare census tracts both within a single city as well as across different areas of the country. For example, census tract area 2010A enclosed by census tract border 2012A does not have the same shape nor necessarily the same area as any other census tract locally or nationwide. Consequently, no governmental geographic level is sufficient for comparing, processing, and displaying data. A standardized congruent geographic partitioning such as hexagonal partitioning 2000B (hexbins) of FIG. 2B, in which hexbin areas 2010B enclosed by hexbin borders 2012B form a substantially regular repeating pattern of hexbins with equidistant spacing between adjacent centroids of the hexbins, allows for direct comparison between hexbins across various regions.

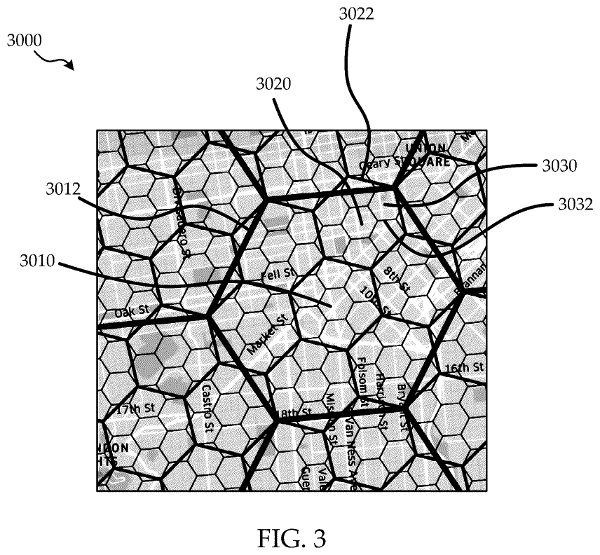

Referring to FIG. 3, a hexagonal hierarchical geospatial indexing system such as H3 provides an ideal geographic level of partitioning. A grid system, H3 partitions the Earth into hexbins (and a few pentagonal cells) at many different scopes or levels of resolution. At low levels of resolution, each hexbin covers a large portion of land, and as the resolution increases, the coverage of each hexbin decreases. The flexibility of H3 allows determination of the optimal focus for the problem. Moreover, within the same resolution, hexbins are substantially the same size and the centroids of the hexbins are equidistant from the adjacent centroids throughout. As illustrated in FIG. 3, H3 hexbins 3000 at higher resolutions fall almost completely within the hexbin at lower resolutions. For example, hexbin area 3010 enclosed by hexbin border 3012 at the lowest resolution, encompasses most of hexbin area 3020 enclosed by hexbin border 3022 at the next higher resolution, which itself encompasses most of hexbin area 3030 enclosed by hexbin border 3032 at the highest resolution depicted. It should be noted that although FIG. 3 shows hexbins at only three different levels of resolution, more levels may be used. In some embodiments, the H3 grid is used to abstract the surface of the United States at a relatively granular level (resolution #7) while avoiding running a custom trade area for each individual building footprint across the US. This level is used for storing and processing of data from which the demand gap is determined, as well as the level at which the demand gap information is presented to a user, in the form of a hexagonal map or overlay. Using H3 at resolution 7 provides a balance between a high enough resolution to provide differentiation and identification of opportunities for development while providing a large enough geographic area for each hexbin to remain meaningful, both in terms of the data associated therewith and for purposes of display to a user.

As is apparent from the foregoing, H3 provides levels of usability for processing and presentation as well as consistency for comparison between different regions balancing intelligibility, meaningfulness, precision, and performance. It should be noted however, that currently none of the data from external governmental sources exists at the H3 level. Consequently, implementing a system which can take advantage of H3 for storage, processing, and presentation, involves some aggregation of the data to H3. However, rather than aggregating and distributing the geographic point and/or geographic polygon associated data directly to the H3 level 7 hexbins (hereinafter simply “hexbins”), consideration is made for what form the estimation of the demand gap should take. As will be described below, in the embodiments described herein, the demand gap estimated and visualized for the hexbins is not solely defined by the data bounded within or intersecting each hexbin itself. Another form, a custom geographic polygon extending beyond and surrounding each hexbin, is used in the aggregation of data and the estimation of the demand gap associated with the hexbin which forms the locus for the information being displayed.

Determining a useful and accurate demand gap to associate with a hexbin depends upon a reliable and accurate assessment of the difference between the demand for service levels associated with potential development locations within a hexbin as well as the actual service levels being provided for a population with access to the hexbin. As mentioned above, there are considerations for balancing which hexbin size to use. One of the considerations is that for presenting opportunities for business locations, a higher resolution is generally desirable, since particularly favorable sites should be as differentiable as possible from less favorable sites, and in as much geographical detail as is reasonable. A trade off to greater hexbin display resolution is a potential requisite loss or disassociation of information strictly falling outside of that hexbin, which typically would not be associated with the hexbin. Various data associated with multiple surrounding hexbins, however, are in fact relevant to a real-world assessment of both supply and demand associated with the potential locations within the hexbin, particularly since customers and suppliers (e.g. patients and physicians) can access each other over relatively longer distances than the span of a single hexbin of a favorably high resolution. Since factors affecting the demand gap of any particular hexbin are likely to have more of an effect the closer they are, the data taken into account for assessing the demand gap should be limited to some maximum area of influence but extending beyond and surrounding the hexbin.

As mentioned above, the solution is to assign to each relatively high resolution hexbin a relatively larger trade area from which to include data which affects both the demand and supply characteristics attributable to locations within the hexbin, the trade area defined by a custom geographic polygon for aggregation of the data. Generally speaking, the data which are associated with geographic points or geographic polygons which are encompassed by or intersect with the custom geographic polygon of a hexbin, are defined as being part of the trade area and are associated with that hexbin.

There are two main ways to generate custom geographic polygons for aggregation: using distance or travel time. Distance can be a good proxy, as longer distances usually take a longer time to trek, but in real life examples, people tend to care more about the amount of time spent rather than any maximum distance they are willing to travel. Similar considerations are applicable to some industries for which delivery time is a more important factor than mileage. In the case of customers or patients travelling, determining which grocery store or primary care office to go to is more dependent on whether it takes 10 minutes or an hour to get there, versus whether it is 1 mile or 10 miles away, all else being equal. Therefore, while distance is easier to calculate, the aggregation of data to a trade area should be based on the amount of time it takes to travel.

Accordingly, instead of using a maximum distance, a custom geographic polygon defined by a maximum time of travel is used, and in some embodiments this maximum travel time is 30 minutes, as this is the maximum travel time people are typically willing to travel for service. In some embodiments, depending upon the particular industry sector, the particular services provided and the particular demographics of the customers, this maximum travel time may be different. In each embodiment, the same travel time is utilized for defining the custom geographic polygon for every hexbin, ensuring consistency for reliable comparison and differentiation between hexbins.

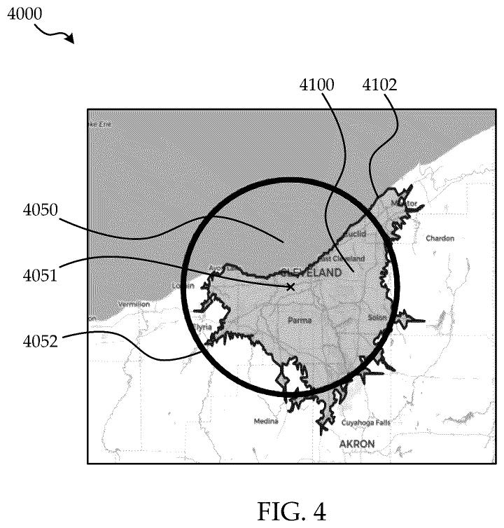

Defining a polygon based on travel times results in an isochrone. FIG. 4 illustrates for a given region 4050 generally surrounding a centroid, the difference between a circle 4052 centered on a centroid 4051 and a polygonal isochrone 4102 defined by a travel time from that centroid 4051. In respect of variables which are related primarily by travel times, although the radius of the circle 4052 is easy and quick to calculate, it is much less useful than the polygonal isochrone 4102 for estimating the demand gap.

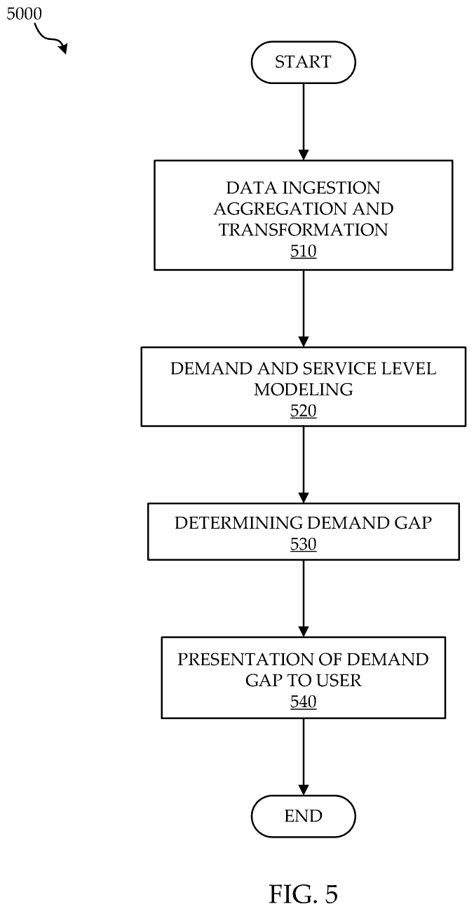

Referring also to FIG. 5, a location strategy method 5000 performed by the location strategy engine 1330 and various other components of the system 1000 acting therewith for providing location strategy services, will now be discussed.

Data ingestion, aggregation, and transformation 510 involves the ingestion process 1010, transformation process 1020, and data science modeling process 1030 accessing data from the various sources 1002 1004 1006, processing them and updating and storing the data in the databases 1110 1120 1130. Only after the relevant data are processed and in place in the databases 1110 1120 1130 would the method then proceed to demand and service level modeling 520 during which a statistical and/or machine learning model is developed.

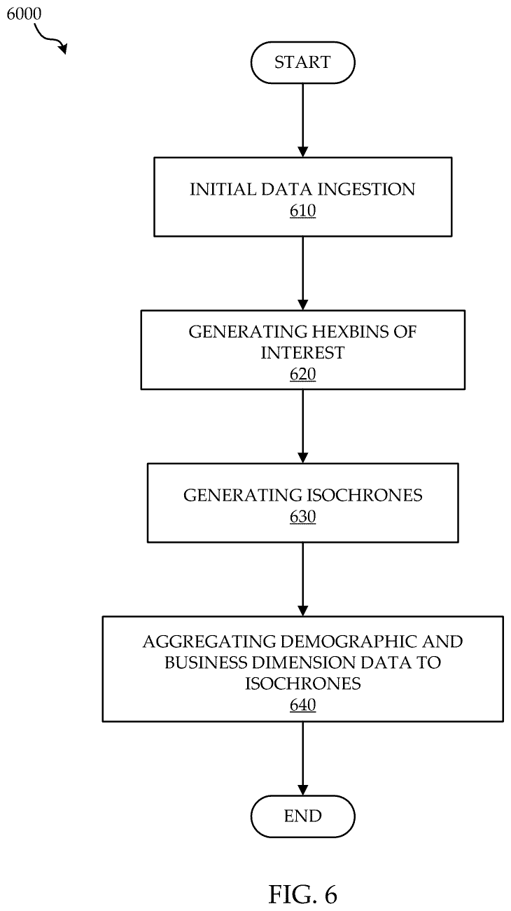

With reference also to FIG. 6, the process 6000 of data ingestion, aggregation, and transformation 510 of FIG. 5 will now be discussed in further detail. Initial data ingestion 610 is the process which initially ingests data for the system and distributes it to the various processes and databases of the system. The data comes in two major types or categories of data, geospatial data, which is eventually stored in geospatial database 1130 and various demographic and business-related data stored in the core data model database 1110 or the metrics database 1120 and indexed by or associated with objects stored in the geospatial database 1130. As noted above, only certain factual data is ingested directly to the core data model 1110 without any further transformation, aggregation, or processing.

As noted hereinabove, various data are ingested into the system including data from external data sources 1002, other files 1006, and data APIs 1004. External data sources 1002 may include private sector databases, including such data as demographic and business dimension data often offered for a fee and often associated with or indexed on the basis of standard or governmental geographic levels (defined by census block group or other governmental boundaries), e.g. population density of each census tract across the entirety of the United States. Some external data sources 1002 may be compiled and provided by the government or other institutions, sometimes made available for free such as business or industry registries. An example of such a database is the National Provider Identifier registry (NPI) for all physicians and health practitioners in the United States, which includes such data as practice address, name, area of medicine etc. In general data from external sources 1002 may include statistical data associated with or indexed by geographic levels or come in the form (as is the NPI) of data associated with or including location data such as street addresses. Data falling under the category of other files 1006 include generated or gathered proprietary data which may have originated externally but has since been processed to a large degree or may include data independently gathered in-house by the entity implementing the systems referred to herein. In some embodiments, the geographic level at which the data of the other files 1006 is stored, is a proprietary one with unique shapes, areas, and/or boundaries, while in others proprietary data is stored and associated with census block groups or other governmental boundaries.

In embodiments implemented in the context of the healthcare industry, all of the relevant NPI data for the region of interest is ingested into the system during the initial data ingestion process of step 610. The practice address data associated with each practitioner is used to fetch through a geocoding API, the geographic point location of the practice address of the practitioner. These new geographic location data are stored and associated with each practitioner. The geocoding API is also used to convert any street address or other locational data encoded in non-geolocational formats of any of the other relevant demographic or business-related data, into a geolocation including latitude and longitude data defining that location.

In addition to the NPI data, during the initial data ingestion process step 610 all of the relevant demographic and business dimension data are ingested into the system. In some embodiments, this data includes: ‘affluence_and_education_dd’, ‘age_dd’, ‘agriculture_bd’, ‘agriculture_dd’, ‘arts_and_outdoor_recreation_bd’, ‘automotive_sector_bd’, ‘central_business_district_dd’, ‘college_dd’, ‘commuting_times_dd’, ‘construction_bd’, ‘construction_workers_dd’, ‘cultural_bd’, ‘density_dd’, ‘economic_distress_dd’, ‘educators_dd’, ‘engineering_bd’, ‘family_status_dd’, ‘general_and_light_manufacturing_bd’, ‘general_industrial_bd’, ‘government_bd’, ‘government_workers_dd’, ‘grocery_bd’, ‘health_care_workers_dd’, ‘hospitality_workers_dd’, ‘hotels_bd’, ‘institutional_population_dd’, ‘large_employers_bd’, ‘legal_services_bd’, ‘manufacturing_workers_dd’, ‘medical_bd’, ‘military_dd’, ‘mining_bd’, ‘neighborhood_age_dd’, ‘nursing_and_residential_care_bd’, ‘personal_services_bd’, ‘r&d_bd’, ‘recent_growth_dd’, ‘religious_institutions_bd’, ‘rental_affordability_dd’, ‘repair_and_maintenance_bd’, ‘restaurants_bd’, ‘retail_bd’, ‘retirement_dd’, ‘rising_fortunes_dd’, ‘sales_workers_dd’, ‘seasonal_housing_dd’, ‘service_workers_dd’, ‘small_business_bd’, ‘small_finance_insurance_and_real_estate_bd’, ‘tech_bd’, ‘tourism_bd’, ‘transportation_bd’, ‘transportation_workers_dd’, and ‘wholesale_and_warehousing_bd’. Data variables with the postscript “dd” are demographic dimensions while variables with the postscript “bd” are business dimensions.

As can be seen in the aforementioned list of data variables, the data which is used to determine an expected demand for each hexbin include demographic factors, which have consistently been found to impact healthcare demand such as age, education, and income. In addition to demographic factors, business dimensions have also been included, as people may be more inclined to use a doctor because they are close to their place of work. These demographic and business features are included at several geographic levels (e.g. census block, census tract, etc.). Some embodiments may include more data or other data and/or exclude some or all of the aforementioned data. It should be noted that the variables which affect the estimation for expected demand and service levels in general should be chosen so as not to waste storage or processing resources. Though the relationship is likely more complex than can be realistically modeled exactly, a suite of quantifiable variables that likely have an impact on the estimation can be determined and certain available data could be ignored if clearly irrelevant. The problem of location strategy is also domain specific, and hence different subsets of the aforementioned data can have greater or lesser predictive value for different domains, such as primary care versus physical and occupational therapy versus dermatology versus cardiology. In some embodiments where resources are limited, these subsets of the data variables depending upon the domain can be the focus for building the model, but for some systems with comparatively larger resources, all of the aforementioned data can be ingested and utilized as described below for greater completeness and accuracy regardless of the domain of inquiry.

At step 620, data science modeling 1030 accesses a hexbin library API to identify which hexbins (resolution level 7) fall within or intersect each of one or more proprietary geographic polygons of interest, generating a list of hexbins of interest and their associated geospatial data for storage in the geospatial database 1130. For example, a set of hexbins falling within a proprietary geographic polygon designating the boundary of a city or an extended region including a city, CBSA etc. which is of interest. The set of hexbins of interest will be used for storage, processing, and presenting the demand gap to a user.

In some embodiments, an external isochrone API is utilized to generate the custom geographic polygon corresponding to an isochrone associated with each hexbin of interest. The geographic point corresponding to the centroid of each hexbin of interest is used as the point of origin for generating the isochrone, which in some embodiments is defined by boundary lines having geographic points located on the vehicular public infrastructure at a 30-minute drive time from that point of origin or from a point of origin defined by the nearest portion of vehicular public infrastructure to that centroid. Accordingly, at step 630, an isochrone API is then accessed by data science modeling 1030 through ingestion process 1010. The data science modeling 1030 sends the centroid of each hexbin of interest to the isochrone API along with parameters defining a 30-minute drive time. The isochrone API returns an isochrone in the form of a custom geographic polygon which is then stored in the geospatial database 1130 and associated with the respective hexbin whose centroid was used to define it. As noted above the resolution of the hexbins are such that the trade areas they are associated with extend beyond their boundaries often overlapping multiple other hexbins. However, this is expected since the demand gap being defined and measured is meant to represent the business development opportunity of potential locations within the hexbin, which is dependent upon factors reaching well beyond the borders of the hexbin and very much depends upon the access infrastructure associated therewith. Each isochrone stored in the geospatial database 1130 is associated with the relevant data for determining the demand gap which is then associated with the respective hexbin as described below.

It should be understood that in some embodiments, internal APIs or other local processing may be utilized instead of or in combination with external APIs to determine the hexbins of interest, the geolocations of the practice addresses, and the isochrones centered on each of the hexbins of interest.

Once the isochrones for all hexbins of interest have been determined, defined, and associated with each corresponding hexbin, all relevant ingested data is transformed and aggregated to the hexbins at step 640 by aggregating the relevant demographic and business dimension data with use of the polygonal isochrone associated with the hexbin. As mentioned above, the various data sources come in many different geographic forms, for example, provider and organization data, having street addresses which can be associated with a latitude and longitude, constitute site or location-based data, while demographic and employment information stored at the census tract, zip code/county or similar level, constitute geographic area-based data.

Geographic area-based data whose associated geographic area overlaps these custom geographic polygons defining the isochrones (hereinafter simply referred to as “isochrones”) and site or location-based data whose site or location falls within or near isochrones in general should be associated with those isochrones.

In some embodiments, the site or location data (such as NPI data) whose site or location falls within an isochrone is associated with that isochrone and consequently associated with the hexbin associated with the isochrone. In other embodiments, an intermediate geographic level such as the census block group (BG) level, is used to aggregate all of the data prior to aggregation to the isochrones. In those cases, all the site or location-based data is first transformed or aggregated to the BG geographic polygons, resulting in new geographic area-based data, being the sum of the site or location data for the BG, i.e. a total number of practitioners within the BG. The total number of practitioners within those BGs is then aggregated to the isochrones. For example, the NPI data associated with sites or locations falling within a BG geographic polygon are summed to generate the new NPI data per BG and associated with the BG. It should be noted, that since the BG boundaries do not overlap, each NPI site or location falls within only one BG geographic polygon.

Next, all the geographic area-based data is then aggregated to the isochrone level and associated with the corresponding hexbins. First, the embodiments determine which BGs fall within or intersect which isochrones. If the geographic polygon of any BG falls entirely within or intersects with an isochrone, then that BG is associated with the hexbin associated with the isochrone. Consequently, each hexbin will be associated with a plurality of BGs, and due to the overlapping nature of the isochrones, BGs may be associated with more than one hexbin. Each hexbin will then have associated with it, the NPI as well as the demographic and business dimension data of the multiple BGs associated with the hexbin. Next is the process of aggregating each data variable type separately characterizing each of the multiple BGs per hexbin into a single value of that data variable type characterizing each hexbin. This aggregation differs for data variable types which are discrete and thus should be summed versus data variable types which are mean based and should be combined using a mean or averaging based approach.

This aggregation of data performed by the embodiments uses a distance weighting approach so that data closer to the centroid of the hexbin have a relatively higher weighting whereas data farther from the centroid have a relatively lower weighting. This is done in order to generate a more accurate value for the data, as values closer to the centroid of the hexbin are more representative than values on the edges of the isochrone.

For mean based data a standard Inverse Distance Weighting (IDW) is utilized according to the equation (1):

$${m}_{p} = \frac{{\sum }_{i = 1}^{n} ( \frac{{m}_{i}}{{d}_{i}^{p}} )}{{\sum }_{i = 1}^{n} ( \frac{1}{{d}_{i}^{p}} )} \qquad ( 1 )$$

Here, mᵢ are the individual BG mean based data associated with the ith BG, n is the number of BGs which are associated with a hexbin (i.e. fall within or intersect the hexbin's isochrone), dᵢ is the distance between the hexbin's centroid and the centroid of the ith BG polygon, p is a pre-determined power parameter which determines how the distance affects the weighting, and mₚ is the newly generated aggregated data value which is to be associated with the hexbin.

For sum-based data, such as the number of practitioners or physician count (from the NPI data per BG), a variation of IDW is utilized according to equation (2) to obtain a count attributable to each hexbin:

$${s}_{p} = {\sum }_{i = 1}^{n} ( \frac{{s}_{i}}{{d}_{i}^{p}} ) \qquad ( 2 )$$

Here, sᵢ are the individual BG sum based data associated with the ith BG, n is the number of BGs which are associated with a hexbin (i.e. fall within or intersect the hexbin's isochrone), dᵢ is the distance between the hexbin's centroid and the centroid of the ith BG polygon, p is a pre-determined power parameter which determines how the distance affects the weighting, and sₚ is the newly generated aggregated data value which is to be associated with the hexbin.

Although the power parameter p may be context dependent, in some embodiments, a power p of two (2) was found to produce accurate and intelligible results. It should be noted that most of the relevant demographic and business dimension data is mean based and hence is aggregated to each hexbin according to equation (1).

It should be noted that the various data associated with each hexbin's isochrone is generated on a regular basis and hence step 510 of FIG. 5 may also be repeated to update the system on some periodic basis. For example, as the underlying datasets are updated, through step 510, the values associated with each hexbin are updated as well. Depending upon the amount of data involved and processing available this could be performed on any regular or irregular basis on the order of daily, weekly, monthly, or yearly. In some embodiments, this can be a dynamic process.

Once all data have been ingested, transformed, and aggregated in step 510, demand and service level modeling 520 may begin. In some embodiments, this modeling is primarily performed by data science modeling 1030 with or without the help of transformation process 1020. As noted above, the determination of the demand gap relies on an estimation of what the demand is in order to compare it with an assessment of how much of that demand is being satisfied. As a first approximation the number of practitioners typically throughout various regions in various demographic and business contexts, forms a solid basis for estimating the demand of similar regions. The assumption made here is that although specific individual regions may be over-serviced or under-serviced by the number of practitioners present in the region, on average or in the aggregate, numbers of practitioners, through operation of market conditions, provide the level of services commensurate with demand which in turn is exhibited in accordance with the specific context. Accordingly, algorithms which are particularly good at pattern recognition such as machine learning algorithms such as Histogram Gradient Boosting Regressors and the like, are capable of determining what on average to expect, in term of service provided (i.e. practitioners), from a region having a certain constellation of demographic and business dimensions. Some embodiments utilize statistical algorithms instead of machine learning, while others utilize some combination of statistical algorithms and machine learning.

Although in some embodiments, the number of practitioners can be used, of particular interest is the variable “practitioners per million people”. Although one might assume that the population or population density could be taken into account properly, in a similar manner as all of the other data used by the statistical or machine learning algorithm in generating estimations for the expected numbers of practitioners, the overall results can be improved and further shielded from any overdetermination effects of population by focusing on a “practitioners per million people” value as the target variable. This target variable is aggregated and processed from the data first, allowing that target variable to be used for both generating the model and in the process of demand gap determination. Accordingly, in some embodiments, prior to running the statistical or machine learning algorithm, the number of practitioners for each hexbin is divided by the total population associated with the isochrone of the hexbin and multiplied by one million to obtain a “practitioners per million people” value for each hexbin. This is the standardized variable of interest upon which the demand and service level modeling and demand gap estimation are based.

In some embodiments, the model is trained using service line specific data in order to obtain more accurate results per service line, for example primary care, cardiology, or dermatology, etc. In such a case rather than simply practitioners per million people, the system separately tracks practitioners per million people of each type, as well as separately models and predicts the demand gap therefor. In some embodiments further segmentation into physicians versus practitioners is implemented to obtain even more specialized and potentially accurate results when particular focus is desired. In some embodiments, to capture any wider cultural, demographic, business, or other dimension which may be systemic to a particular region or city, further segmentation across geographic, political, or economic environments is implemented. Although generally the more data the more accurate the model, in some embodiments, where implementation of memory or processing is limited, even further segmentation to reduce overall data and processing times may be implemented.

With each kind of “practitioners per million people” of interest as the focus, the statistical or machine learning algorithm (e.g. Histogram Gradient Boosting Regressor) is fed all of the relevant data such as that noted above, aggregated to each hexbin via its isochrone. The model is generated or trained to associate any of the vast array of unique combinations of demographic, business, and any other available data associated with a hexbin with an expected “practitioners per million people” value for a hexbin having that combination. Although dependent upon segmentation mentioned above, training is performed across as large a base sample of data as possible, for example, throughout a wide region, a state, or across the entire United States so that as much information as possible goes into the generation of the model. Accordingly, when input with a specific set of demographic and business dimension data associated with a particular hexbin, the model returns a value for the expected “practitioners per million people” for that hexbin. In practice, the demand and service level model is provided with a list of hexbins of interest and all the relevant data associated with each of those hexbins is used by the model to estimate and return the expected “practitioners per million people” for each hexbin of interest. It should be noted that by utilizing a standard regular geographic polygon such as a hexbin as the basis for defining relatively larger trade zones based on drivetime isochrones, and aggregating the relevant data using said isochrones prior to training the model, improves the accuracy and performance of the system versus various other approaches.

In order to estimate the demand gap in step 530 per hexbin, the expected “practitioners per million people” per hexbin is compared with an empirical real-world measure of “practitioners per million people” per hexbin. In some embodiments this value is already present and associated with each hexbin, since it is the same dependent variable used in training the model. The value of that variable in the databases however, may be updated more frequently via aggregation and transformation with updated external data, than the model itself. Accordingly, although it is the same variable as that used to train the system, it can easily have a different specific value for each hexbin versus when the system was trained. If it can be assumed that generally the model once formed and trained is correct, and that the same general causal factors are at play over the long term, the model may be updated or retrained infrequently. In some embodiments, determining the demand gap 530 is primarily performed by data science modeling 1030 sometimes in cooperation with the location strategy engine 1330.

To determine the estimated demand gap 530, the expected “practitioners per million people” for each hexbin of interest is compared with the actual “practitioners per million people” stored in association with the hexbin. In some embodiments, the comparison is a straight difference, for example, the expected minus the actual “practitioners per million people”, which results in an absolute number type of demand gap which can be presented to the user at step 540. In such embodiments, numbers near zero are represented so as to be recognized as being appropriate or close to appropriate service levels, whereas positive numbers are represented so as to be recognized as underserved areas, and negative numbers are represented so as to be recognized as overserved or saturated areas. In some embodiment, the comparison determines the ratio between expected and actual service level, or takes the form of any other useful comparison given the context of the particular service, geography, and other factors.

In some embodiments utilizing a straight difference, prior to presentation to the user, the demand gap for each hexbin is multiplied by the population (of the isochrone of the hexbin) and divided by one million, to convert the units of demand gap for display from “the gap in the number of practitioners per million people” to simply “the gap in the number of practitioners”.

In some embodiments, presentation of the demand gap to the user 540 (primarily managed by the location strategy engine 1330) provided via a location strategy tool UI, may involve a map overlay of hexagonal display shapes (hereinafter “display hexagon”), each representing a corresponding hexbin, and color coded in accordance with the demand gap along with optionally a legend informing the user of the correspondence of the displayed color with its demand gap value. In some embodiments, the possible colors of each display hexagon are organized such that they fall into a discrete number of levels, while in other embodiments a continuous range of possible colors is used. In some embodiments, the transparency of each display hexagon may be varied also to represent in a meaningful way the demand gap associated with each corresponding hexbin. Users viewing the various colors of the display hexagons in the overlay can quickly and intuitively get a sense of which of hexbins represented thereby possess the most opportunistic demand gap and hence provide the greatest opportunity for development.

In some embodiments, modification of data sources allows the platform to accommodate multiple business use cases, centered on specific industry segments and the distinct roles stakeholders play in the area of commercial real estate. The platform could accommodate multiple use cases by tailoring the UI/UX to these specific user personas based on a user's subscription details.

It is to be understood that the component parts of the location strategy system may operate as part of a single apparatus or device or may operate as part of a multiplicity of interconnected devices working together in proximity or remotely, or any combination thereof. In addition, two or more computing systems or devices may be substituted for any one of the processes or modules described herein. Accordingly, principles and advantages of distributed processing, such as redundancy, replication, and the like, also can be implemented, as desired, to increase the robustness and performance of processors, layers, or databases described herein. The various local or remote computing platforms include drives and/or their associated computer storage media to provide storage of machine readable instructions, data structures, program modules and other data for the system. The machine readable instructions may comprise an algorithm for execution by: (a) a processor, (b) a controller, and/or (c) one or more other suitable processing device(s) including a cloud computing platform. The algorithm may be embodied in software stored on tangible media such as, for example, a flash memory, a CD-ROM, a floppy disk, a hard drive, a flash drive, a digital video (versatile) disk (DVD), any memory capacity associated with cloud services if applicable, or other memory devices, but persons of ordinary skill in the art will readily appreciate that the entire algorithm and/or parts thereof could alternatively be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), discrete logic, etc.) or executed by a processing of a cloud computing platform. Any or all of the component processes or steps of the method herein described could be implemented by software, hardware, and/or firmware.

A user may enter commands and information into the hardware associated with and accessing the identity and personalization layer 1400 using a user interface, which may include input devices such as a keyboard and pointing device (e.g. a mouse, trackball, touch pad, etc.). Input devices may also include a microphone, tablet, or the like. A monitor or other type of display device may be connected to the system via an interface, such as a video interface, for display of the demand gap on a graphical user interface (“GUI”). The GUI may also be used to receive instructions from the user interface and transmit instructions to the application layer for specifying use cases, areas of interest, customizing the display of the demand gap, or for any other input facilitating the operation of the location strategy system described herein.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A computer implemented method of assisted location strategy, carried out by a computer system, the method comprising:
ingesting demographic, business, and service data into the computer system;
receiving an input from a user specifying an area of interest;
generating a list of regular geographic polygons falling within the area of interest; and
for each regular geographic polygon, generating a respective custom geographic polygon as a trade area for the regular geographic polygon, the custom geographic polygon generated from the centroid of the regular geographic polygon and extending beyond the area of the regular geographic polygon;
aggregating the demographic, business, and service data to the custom geographic polygons and associating the aggregated data with the regular geographic polygon;
training a demand and service level model with use of the aggregated data;
determining a demand gap for each regular geographic polygon with use of the trained model and the aggregated data associated with the regular geographic polygon; and
presenting the demand gap to the user via a display device of the computer system.

2. The method of claim 1, wherein each regular geographic polygon is a level 7 hexbin of an H3 geographic partitioning system.

3. The method of claim 2, wherein each custom geographic polygon is an isochrone generated from the centroid of each hexbin.

4. The method of claim 3, wherein each isochrone is defined using a 30-minute drive time.

5. The method of claim 3, wherein aggregating the demographic, business, and service data to the isochrones includes:
for each isochrone, determining whether each standard geographic polygon with which the data is associated falls within or intersects with the isochrone, and if so, associating the standard geographic polygon with the isochrone; and
for each isochrone, aggregating the data of the associated standard geographic polygons into new data associated with the isochrone.

6. The method of claim 5, further comprising, prior to aggregating the data to the isochrones:
aggregating geographic location-based data to each standard geographic polygon, including, determining whether the geographic location with which the geographic location-based data is associated falls within the standard geographic polygon, and if so, aggregating the geographic location-based data to the standard geographic polygon generating data associated with the standard geographic polygon.

7. The method of claim 5, wherein aggregating the data into new data associated with the isochrone comprises performing an inverse distance weighting of the data of the associated standard geographic polygons, for data which is mean based.

8. The method of claim 7, wherein aggregating the data into new data associated with the isochrone comprises performing a variation of inverse distance weighting of the data of the associated standard geographic polygons, according to
$${s}_{p} = {\sum }_{i = 1}^{n} ( \frac{{s}_{i}}{{d}_{i}^{p}} )$$
for data which is sum based.

9. The method of claim 8, wherein the demand and service level model is trained to return an expected level of demand associated with a hexbin based on the aggregated data associated with the respective isochrone of the hexbin.

10. The method of claim 9, wherein determining the demand gap for each hexbin comprises comparing the expected level of demand returned by the demand and service level model for the hexbin with a demand determined from the aggregated data associated with that hexbin.

11. A computer system for implementing a method of assisted location strategy, the computer system being configured to:
ingest demographic, business, and service data into the computer system;
receive an input from a user specifying an area of interest;
generate a list of regular geographic polygons falling within the area of interest; and
for each regular geographic polygon, generate a respective custom geographic polygon as a trade area for the regular geographic polygon, the custom geographic polygon generated from the centroid of the regular geographic polygon and extending beyond the area of the regular geographic polygon;
aggregate the demographic, business, and service data to the custom geographic polygons and associate the aggregated data with the regular geographic polygon;
train a demand and service level model with use of the aggregated data;
determine a demand gap for each regular geographic polygon with use of the trained model and the aggregated data associated with the regular geographic polygon; and
present the demand gap to the user via a display device of the computer system.

12. The computer system of claim 11, wherein each regular geographic polygon is a level 7 hexbin of an H3 geographic partitioning system.

13. The computer system of claim 12, wherein each custom geographic polygon is an isochrone generated from the centroid of each hexbin.

14. The computer system of claim 13, wherein each isochrone is defined using a 30-minute drive time.

15. The computer system of claim 13, wherein aggregating the demographic, business, and service data to the isochrones includes:
for each isochrone, determining whether each standard geographic polygon with which the data is associated falls within or intersects with the isochrone, and if so, associating the standard geographic polygon with the isochrone; and
for each isochrone, aggregating the data of the associated standard geographic polygons into new data associated with the isochrone.

16. The computer system of claim 15, wherein the computer system is further configured to, prior to aggregating the data to the isochrones:
aggregate geographic location-based data to each standard geographic polygon, including, determining whether the geographic location with which the geographic location-based data is associated falls within the standard geographic polygon, and if so, aggregating the geographic location-based data to the standard geographic polygon generating data associated with the standard geographic polygon.

17. The computer system of claim 15, wherein aggregating the data into new data associated with the isochrone comprises performing an inverse distance weighting of the data of the associated standard geographic polygons, for data which is mean based.

18. The computer system of claim 17, wherein aggregating the data into new data associated with the isochrone comprises performing a variation of inverse distance weighting of the data of the associated standard geographic polygons, according to
$${s}_{p} = {\sum }_{i = 1}^{n} ( \frac{{s}_{i}}{{d}_{i}^{p}} )$$
for data which is sum based.

19. The computer system of claim 18, wherein the demand and service level model is trained to return an expected level of demand associated with a hexbin based on the aggregated data associated with the respective isochrone of the hexbin.

20. The computer system of claim 19, wherein determining the demand gap for each hexbin comprises comparing the expected level of demand returned by the demand and service level model for the hexbin with a demand determined from the aggregated data associated with that hexbin.
